(19) United States
(12) Patent Application Publication
(10) Pub. No.: US 2011/0171400 A1
(43) Pub. Date: Jul. 14, 2011

(54) OPTICAL BONDING WITH SILICON-CONTAINING PHOTOPOLYMERIZABLE COMPOSITION

(76) Inventors: David Scott Thompson, West Lakeland, MN (US); Larry D. Boardman, Woodbury, MN (US); Chien-Chih Chiang, Taiwan (CN); Huang-Chin Hung, Taiwan (CN); Kuo-Chung Yin, Taiwan (CN)

(21) Appl. No.: 12/991,138

(22) PCT Filed: Apr. 9, 2009
(86) PCT No.: PCT/US09/40000

§ 371 Date: Mar. 29, 2011

Related U.S. Application Data
(60) Provisional application No. 61/051,238, filed on May 7, 2008.

(51) Int. Cl. G02F 1/335; C09K 19/52; B32B 9/00; C08F 2/48

(52) U.S. Cl. 428/1.32; 428/339; 156/275.5

(57) ABSTRACT

An optical assembly including a display panel is disclosed herein. The display panel is optically bonded, using a photopolymerized layer, to a substantially transparent substrate. The photopolymerized layer is formed from a photopolymerizable layer having a silicon-containing resin comprising silicon-bonded hydrogen and aliphatic unsaturation and a platinum photocatalyst present in an amount of from about 0.5 to about 30 parts of platinum per one million parts of the photopolymerizable layer. Methods of making the optical assembly are also disclosed herein. The optical assembly may be used in an optical device such as a handheld device, a television, a computer monitor, a laptop display, or a digital sign.

### FIELD OF THE INVENTION

This invention relates to optical bonding of optical components, and more particularly, to optical bonding of display components using silicon-containing photopolymerizable compositions.

### BACKGROUND

Optical bonding may be used to adhere together two optical elements using an optical grade adhesive. In display applications, optical bonding may be used to adhere together optical elements such as display panels, glass plates, touch panels, diffusers, rigid compensators, heaters, and flexible films such as polarizers and retarders. The optical performance of a display can be improved by minimizing the number of internal reflecting surfaces, thus it may be desirable to remove or at least minimize the number of air gaps between optical elements in the display.

### SUMMARY

An optical assembly comprising a display panel is disclosed herein. In one aspect, the optical assembly comprises: a display panel; a substantially transparent substrate; and a photopolymerizable layer disposed between the display panel and the substantially transparent substrate, the photopolymerizable layer having a thickness of from greater than 10 um to about 12 mm and comprising: a silicon-containing resin comprising silicon-bonded hydrogen and aliphatic unsaturation, and a platinum photocatalyst present in an amount of from about 0.5 to about 30 parts of platinum per one million parts of the photopolymerizable layer. In some embodiments, the display panel may comprise a liquid crystal display panel. In some embodiments, the substantially transparent substrate may comprise a touch screen.

A method of making an optical assembly is also disclosed herein. In one aspect, the method comprises: providing a display panel; providing a substrate comprising a substantially transparent substrate or a polarizer; disposing a photopolymerizable composition on one of the display panel and the substrate, the photopolymerizable composition comprising: a silicon-containing resin comprising silicon-bonded hydrogen and aliphatic unsaturation, and a platinum photocatalyst present in an amount of from about 0.5 to about 30 parts of platinum per one million parts of the photopolymerizable composition; disposing the other of the display panel and the substrate on the photopolymerizable composition such that a photopolymerizable layer having a thickness of from greater than 10 um to about 12 mm is formed between the display panel and the substrate; and photopolymerizing the photopolymerizable layer by applying actinic radiation having a wavelength of 700 nm or less.

In another aspect, the method comprises: providing a display panel; providing a substrate comprising a substantially transparent substrate or a polarizer; forming a seal between the display panel and the substrate so that a cell is formed between the display panel and the substrate, the cell having a thickness of from greater than 10 um to about 12 mm; disposing a photopolymerizable composition into the cell, the photopolymerizable composition comprising: a silicon-containing resin comprising silicon-bonded hydrogen and aliphatic unsaturation, and a platinum photocatalyst present in an amount of from about 0.5 to about 30 parts of platinum per one million parts of the photopolymerizable composition; and photopolymerizing the photopolymerizable composition by applying actinic radiation having a wavelength of 700 nm or less.

The optical assembly disclosed herein may be used in an optical device comprising, for example, a handheld device comprising a display, a television, a computer monitor, a laptop display, or a digital sign.

These and other aspects of the invention are described in the detailed description below. In no event should the above summary be construed as a limitation on the claimed subject matter which is defined solely by the claims as set forth herein.

### BRIEF DESCRIPTION OF THE DRAWINGS

The invention may be more completely understood in consideration of the following detailed description in connection with the following figures:

FIG. 1 is a schematic cross-sectional view of an exemplary optical assembly.

FIG. 2 is a photograph of exemplary and comparative silicon-containing photopolymerized discs.

### DETAILED DESCRIPTION

Optical bonding is a well known process for improving display performance. Display bonding can provide a variety of benefits by eliminating air gaps in a display, including improved sunlight readability, improved contrast and luminance, improved ruggedness and resistance to high shock and vibration, and can eliminate condensation and moisture collection between a display panel and overlay. Given the benefits of display bonding it is surprising that it is still a niche market and bonded displays account for a small fraction of the displays and the many bonded displays are made as an aftermarket activity.

The major reason for the resistance to broad adoption of optical bonding in the display industry is that the options for optical bonding compositions and processes either do not provide adequate long term optical properties (for example polyurethanes can exhibit severe yellowing over time), or the curing properties of the optical bonding composition are not suitable for high speed, high volume manufacturing (RTV silicones have suitable optical properties but require high temperatures and/or long times to cure).

The invention disclosed herein describes optical bonding using a silicon-containing photopolymerizable composition that, when photopolymerized, surprisingly provides both excellent optical performance under extreme conditions as well as fast curing required to enable high speed, high volume manufacturing. The silicon-containing photopolymerizable composition comprises: a silicon-containing resin comprising silicon-bonded hydrogen and aliphatic unsaturation, and a platinum photocatalyst present in an amount of from about 0.5 to about 30 parts of platinum per one million parts of the composition.

The silicon-containing photopolymerizable composition may be used to form a silicon-containing photopolymerizable layer, referred to herein as a photopolymerizable layer, which may be used in optical bonding applications. The photopolymerized layer may provide one or more advantages. For one, the photopolymerizable layer can be photostable and thermally stable. Herein, photostable refers to a material that does not chemically degrade upon prolonged exposure to actinic radiation, particularly with respect to the formation of colored or light absorbing degradation products. Herein, thermally stable refers to a material that does not chemically degrade upon prolonged exposure to heat, particularly with respect to the formation of colored or light absorbing degradation products. In addition, preferred silicon-containing resins are those that possess relatively rapid cure mechanisms (e.g., seconds to less than 30 minutes) in order to accelerate manufacturing times and reduce overall assembly cost.

The refractive index of the photopolymerizable layer can be designed to closely match that of optical components. In general, it is desirable for adjacent components to have refractive indices that are as closely matched as possible so as to minimize the amount of light reflected from the interface between the adjacent components. Light reflected from an interface can result in a decrease in contrast ratio thus affecting, for example, outer viewability.

The photopolymerizable layer also has transparency suitable for optical applications. For example, the photopolymerizable layer may have, per millimeter thickness, a transmission of greater than about 85% at 460 nm, greater than about 90% at 530 nm, and greater than about 90% at 670 nm. These transmission characteristics provide for uniform transmission of light across the visible region of the electromagnetic spectrum which is important to maintain the color point in full color displays.

The photopolymerizable layer made from the silicon-containing photopolymerizable composition can provide a bond which is more robust when compared to layers made from conventional materials such as epoxies. More robust bonding can be obtained because of the elastomeric or gel-like nature of the silicon-containing photopolymerizable composition. The silicon-containing photopolymerizable composition is soft and flexible and can resist adhesive failure if the optical assembly is subjected to significant sudden thermal shock or repeated moderate temperature shocks. Soft and flexible optical bonding compositions can also minimize mechanical stress within the assembly which can cause visual anomalies and luminance irregularities. Some manufacturers have avoided the use of bonding layers between, for example, display panels and other types of optical components, and instead mechanically attach the two items such that an air gap is formed between them. The presence of an air gap, however, leads to increased reflections at the interfaces within the display which adversely affects the brightness and contrast of a display.

The photopolymerizable layer made from the silicon-containing photopolymerizable composition can also provide advantages in that it can be used in a variety of methods used to optically bond optical components.

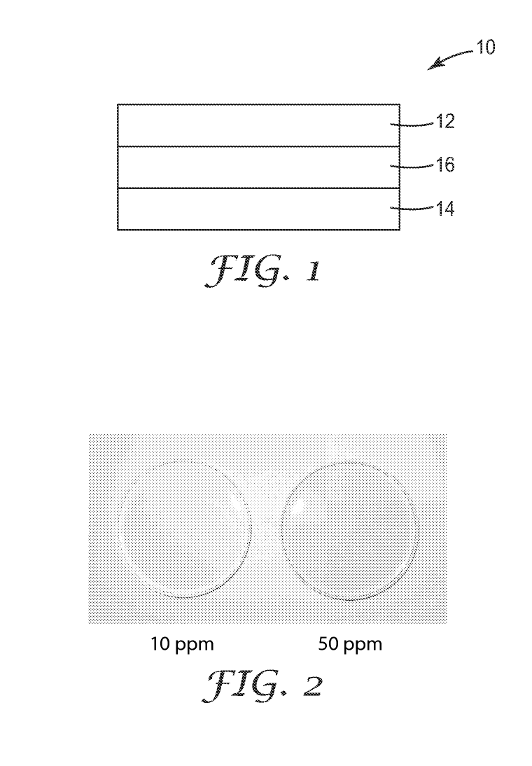

Referring to FIG. 1, there is shown a schematic cross sectional view of an exemplary optical assembly. Optical assembly 10 comprises display panel 12, substantially transparent substrate 14, and silicon-containing photopolymerizable layer 16. The silicon-containing photopolymerizable layer 16 is irradiated with actinic radiation to at least partially polymerize the photopolymerizable layer. The at least partially polymerized layer bonds the display panel 10 and substantially transparent substrate 14 such that they are optically coupled together. The display panel and substantially transparent substrate are bonded together such that, when the optical assembly 10 is moved, the display panel and substantially transparent substrate do not move substantially in relation to one another.

Optical bonding is useful for the application of transparent overlayers to a wide variety of display panels, for example, liquid crystal display panels, OLED display panels, and plasma display panels.

In some embodiments, the optical assembly comprises a liquid crystal display assembly wherein the display panel comprises a liquid crystal display panel. Liquid crystal display panels are well known and typically comprise a liquid crystal material disposed between two substantially transparent substrates such as glass or polymer substrates. As used herein, substantially transparent refers to a substrate that has, per millimeter thickness, a transmission of greater than about 85% at 460 nm, greater than about 90% at 530 nm, and greater than about 90% at 670 nm. On the inner surfaces of the substantially transparent substrates are transparent electrically conductive materials that function as electrodes. In some cases, on the outer surfaces of the substantially transparent substrates are polarizing films that pass essentially only one polarization state of light. When a voltage is applied selectively across the electrodes, the liquid crystal material reorients to modify the polarization state of light, such that an image is created. The liquid crystal display panel may also comprise a liquid crystal material disposed between a thin film transistor (TFT) array panel having a plurality of TFTs arranged in a matrix pattern and a common electrode panel having a common electrode.

In some embodiments, the optical assembly comprises a plasma display assembly wherein the display panel comprises a plasma display panel. Plasma display panels are well known and typically comprise an inert mixture of noble gases such as neon and xenon disposed in many tiny cells located between two glass panels. Control circuitry charges electrodes within the panel cause the gases to ionize and form a plasma which then excites phosphors to emit light.

In some embodiments, the optical assembly comprises an organic electro-luminescent assembly wherein the display panel comprises an organic light emitting diode or light emitting polymer disposed between two glass panels.

Other types of display panels can also benefit from display bonding, for example, electrophoretic displays having touch panels such as those available from E Ink.

The optical assembly also comprises a substantially transparent substrate that has, per millimeter thickness, a transmission of greater than about 85% at 460 nm, greater than about 90% at 530 nm, and greater than about 90% at 670 nm. In a typical liquid crystal display assembly, the substantially transparent substrate may be referred to as a front or rear cover plate. The substantially transparent substrate may comprise glass or polymer. Useful glasses include borosilicate, sodalime, and other glasses suitable for use in display applications as protective covers. Useful polymers include but are not limited to polyester films such as PET, Polycarbonate film or plate, acrylic plate, and cycloolefin polymers, such as Zeonox and Zeonor available from Zeon Chemicals L.P. The substantially transparent substrate preferably has an index of refraction close to that of display panel 12 and/or photopolymerizable layer 16; for example, between 1.45 and 1.55. The substantially transparent substrate typically has a thickness of from about 0.5 to about 5 mm.

In some embodiments, the substantially transparent substrate comprises a touch screen. Touch screens are well known in the art and generally comprise a transparent conductive layer disposed between two substantially transparent substrates. For example, a touch screen may comprise indium tin oxide disposed between a glass substrate and a polymer substrate.

A silicon-containing photopolymerizable composition is used to form the photopolymerizable layer which is then cured to form a photopolymerized layer. The photopolymerizable layer has a thickness of from greater than 10 um to about 12 mm, or from greater than 10 um to about 5 mm. For example, the thickness may be about 254 um. The particular thickness employed in the optical assembly may be determined by any number of factors, for example, the design of the optical device in which the optical assembly is used may require a certain gap between the display panel and the substantially transparent substrate. As described below, the gap between the display panel and the substantially transparent substrate may be mechanically set, for example, by standoffs positioned between the two.

For reasons described above, the photopolymerizable layer preferably has a refractive index that closely matches that of the display panel and substantially transparent substrate. In some embodiments, the photopolymerizable layer is substantially optically transparent. For example, the photopolymerizable layer may have, per millimeter thickness, a transmission of greater than about 85% at 460 nm, greater than about 90% at 530 nm, and greater than about 90% at 670 nm.

After it is cured, the photopolymerizable layer may be in the form of a high molecular weight gum, gel, elastomer, or a non-elastic solid.

The photopolymerizable layer comprises a silicon-containing resin. Preferred silicon-containing resins are selected such that they provide a photopolymerized layer that is photostable and thermally stable.

The silicon-containing resin comprises silicon-bonded hydrogen and aliphatic unsaturation. In general, the silicon-containing resin undergoes metal-catalyzed hydrosilylation reactions between groups incorporating aliphatic unsaturation and silicon-bonded hydrogen. The silicon-containing resin can include monomers, oligomers, polymers, or mixtures thereof. It includes silicon-bonded hydrogen and aliphatic unsaturation, which allows for hydrosilylation (i.e., the addition of a silicon-bonded hydrogen across a carbon-carbon double bond or triple bond). The silicon-bonded hydrogen and the aliphatic unsaturation may or may not be present in the same molecule. Furthermore, the aliphatic unsaturation may or may not be directly bonded to silicon.

In some embodiments, the silicon-containing resin comprises an organosiloxane (i.e., a silicone), which includes an organopolysiloxane. That is, the groups incorporating aliphatic unsaturation and silicon-bonded hydrogen may be bonded to the organosiloxane. In some embodiments, the silicon-containing resin comprises at least two organosiloxanes in which groups incorporating aliphatic unsaturation are part of one organosiloxane and groups incorporating silicon-bonded hydrogen are part of a second organosiloxane.

In some embodiments, the silicon-containing resin comprises a silicone component having at least two sites of aliphatic unsaturation (e.g., alkenyl or alkynyl groups) bonded to silicon atoms in a molecule and an organohydrogensilane and/or organohydrogenpolysiloxane component having at least two hydrogen atoms bonded to silicon atoms in a molecule. Preferably, a silicon-containing resin includes both components, with the silicone-containing aliphatic unsaturation as the base polymer (i.e., the major organosiloxane component in the composition.)

In some embodiments, the silicon-containing resin comprises an organopolysiloxane that contains aliphatic unsaturation and is preferably a linear, cyclic, or branched organopolysiloxane. The silicon-containing resin may comprise an organosiloxane having units of the formula R¹ₐR²_{b}SiO_{(4-a-b)/2} wherein: R¹ is a monovalent, straight-chained, branched or cyclic, unsubstituted or substituted hydrocarbon group that is free of aliphatic unsaturation and has from 1 to 18 carbon atoms; R² is a monovalent hydrocarbon group having aliphatic unsaturation and from 2 to 10 carbon atoms; a is 0, 1, 2, or 3; b is 0, 1, 2, or 3; and the sum a+b is 0, 1, 2, or 3; with the proviso that there is on average at least one R² present per molecule. Organopolysiloxanes that contain aliphatic unsaturation preferably have an average viscosity of at least 5 mPa·s at 25° C.

Examples of suitable R¹ groups are alkyl groups such as methyl, ethyl, n-propyl, iso-propyl, n-butyl, iso-butyl, tert-butyl, n-pentyl, iso-pentyl, neo-pentyl, tert-pentyl, cyclopentyl, n-hexyl, cyclohexyl, n-octyl, 2,2,4-trimethylpentyl, n-decyl, n-dodecyl, and n-octadecyl; aromatic groups such as phenyl or naphthyl; alkaryl groups such as 4-tolyl; aralkyl groups such as benzyl, 1-phenylethyl, and 2-phenylethyl; and substituted alkyl groups such as 3,3,3-trifluoro-n-propyl, 1,1,2,2-tetrahydroperfluoro-n-hexyl, and 3-chloro-n-propyl. In some embodiments, at least 90 mole percent of the R¹ groups are methyl. In some embodiments, at least at least 20 mole percent of the R¹ groups are aryl, aralkyl, alkaryl, or combinations thereof; for example, the R¹ groups may be phenyl.

Examples of suitable R² groups are alkenyl groups such as vinyl, 5-hexenyl, 1-propenyl, allyl, 3-butenyl, 4-pentenyl, 7-octenyl, and 9-decenyl; and alkynyl groups such as ethynyl, propargyl and 1-propynyl. In some embodiments, the R² groups are vinyl or 5-hexenyl. Groups having aliphatic carbon-carbon multiple bonds include groups having cycloaliphatic carbon-carbon multiple bonds.

In some embodiments, the silicon-containing resin comprises an organopolysiloxane that contains silicon-bonded hydrogen and is preferably a linear, cyclic, or branched organopolysiloxane. The silicon-containing resin may comprise an organosiloxane having units of the formula R¹ₐH_{c}SiO_{(4-a-c)/2} wherein: R¹ is as defined above; a is 0, 1, 2, or 3; c is 0, 1, or 2; and the sum of a+c is 0, 1, 2, or 3; with the proviso that there is on average at least 1 silicon-bonded hydrogen atom present per molecule. Organopolysiloxanes that contain silicon-bonded hydrogen preferably have an average viscosity of at least 5 mPa·s at 25° C. In some embodiments, at least 90 mole percent of the R¹ groups are methyl. In some embodiments, at least at least 20 mole percent of the R¹ groups are aryl, aralkyl, alkaryl, or combinations thereof; for example, the R¹ groups may be phenyl.

In some embodiments, the silicon-containing resin comprises an organopolysiloxane that contains both aliphatic unsaturation and silicon-bonded hydrogen. Such organopolysiloxanes may comprise units of both formulae R¹ₐR²_{b}SiO_{(4-a-b)/2} and R¹ₐH_{c}SiO_{(4-a-c)/2}. In these formulae, R¹, R², a, b, and c are as defined above, with the proviso that there is an average of at least 1 group containing aliphatic unsaturation and 1 silicon-bonded hydrogen atom per molecule. In one embodiment, at least 90 mole percent of the R¹ groups are methyl. In some embodiments, at least at least 20 mole percent of the R¹ groups are aryl, aralkyl, alkaryl, or combinations thereof; for example, the R¹ groups may be phenyl.

The molar ratio of silicon-bonded hydrogen atoms to aliphatic unsaturation in the silicon-containing resin (particularly the organopolysiloxane resin) may range from 0.5 to 10.0 mol/mol, preferably from 0.8 to 4.0 mol/mol, and more preferably from 1.0 to 3.0 mol/mol.

For some embodiments, organopolysiloxane resins described above wherein a significant fraction of the R¹ groups are phenyl or other aryl, aralkyl, or alkaryl are preferred, because the incorporation of these groups provides materials having higher refractive indices than materials wherein all of the R¹ radicals are, for example, methyl.

The photopolymerizable layer comprises a platinum photocatalyst. In general, the platinum photocatalyst enables polymerization of the silicon-containing resin via radiation-activated hydrosilylation. The advantages of initiating hydrosilylation using catalysts activated by actinic radiation include (1) the ability to polymerize the photopolymerizable layer without subjecting the display device or any other materials present to harmful temperatures, (2) the ability to formulate one-part photopolymerizable optical compositions that display long working times (also known as bath life or shelf life), (3) the ability to polymerize the photopolymerizable layer on demand at the discretion of the user, and (4) the ability to simplify the formulation process by avoiding the need for two-part compositions as is typically required for thermally polymerizable hydrosilylation compositions.

The photopolymerizable layer comprises a platinum photocatalyst used to accelerate the hydrosilylation reaction. In general, the amount of platinum photocatalyst used in a given photopolymerizable composition or layer is said to depend on a variety of factors such as the radiation source, whether or not heat is used, amount of time, temperature, etc., as well as on the particular chemistry of the silicon-containing resin(s), its reactivity, the amount present in the photopolymerizable layer, etc.

In general, it is known that to increase the cure speed, higher concentrations of a platinum catalyst are desired. Typically, fast cure speeds can be obtained when the amount of platinum photocatalyst used is at least from about 50 to about 1000 parts of platinum per one million parts of the photopolymerizable composition. These higher concentrations, however, result in darkening or yellowing of the polymerized composition when exposed to accelerated environmental testing, for example, storage at 130 C. for 1000 hours. This darkening is not suitable for use in display applications.

Surprisingly, it has been found that a photopolymerized layer suitable for optical applications and having a sufficient thickness can be made from a photopolymerizable layer comprising a very small amount of platinum photocatalyst. Surprisingly, the amount of platinum photocatalyst used does not cause the photopolymerized layer to discolor, yet the reaction speed that forms the layer is acceptable. The photopolymerizable layer comprises the platinum photocatalyst in an amount of from about 0.5 to about 30 parts of platinum per one million parts of the photopolymerizable layer. The platinum photocatalyst may also be used in an amount of from about 0.5 to about 20 ppm, or about 0.5 to about 12 ppm, parts of platinum per one million parts of the photopolymerizable layer. FIG. 2 is a photograph showing side-by-side comparison of two discs, each about 2.7 mm thickness and made from a photopolymerizable composition comprising silicon-containing resin and platinum photocatalyst. Hydrosilylation of components was carried out in the presence of 10 parts of platinum for the disc on the left and 50 parts of platinum for the disc on the right. Details of the experimental procedures can be found in Example 1 and Comparative Example 1 for the discs on the left and right, respectively.

Useful platinum photocatalysts are disclosed, for example, in U.S. Pat. No. 7,192,795 (Boardman et al.) and references cited therein. Certain preferred platinum photocatalysts are selected from the group consisting of Pt(II) β-diketonate complexes (such as those disclosed in U.S. Pat. No. 5,145,886 (Oxman et al.)), (η⁵-cyclopentadienyl)tri(σ-aliphatic)platinum complexes (such as those disclosed in U.S. Pat. No. 4,916,169 (Boardman et al.) and U.S. Pat. No. 4,510,094 (Drahnak)), and C₇₋₂₀-aromatic substituted (η⁵-cyclopentadienyl)tri(σ-aliphatic)platinum complexes (such as those disclosed in U.S. Pat. No. 6,150,546 (Butts)). The photopolymerizable layer can also include a cocatalyst, i.e., the use of two or more metal-containing catalysts.

The photopolymerizable layer can be photopolymerized using actinic radiation having a wavelength of 700 nm or less. The actinic radiation activates the platinum photocatalyst. Actinic radiation having a wavelength of 700 nm or less includes visible and UV light, but preferably, the actinic radiation has a wavelength of 600 nm or less, and more preferably from 200 to 600 nm, and even more preferably, from 250 to 500 nm. Preferably, the actinic radiation has a wavelength of at least 200 nm, and more preferably at least 250 nm.

A sufficient amount of actinic radiation is applied to the photopolymerizable layer for a time such that an at least partially photopolymerized layer is obtained. A partially photopolymerized layer means that at least 5 mole percent of the aliphatic unsaturation is consumed in a hydrosilylation reaction. Preferably, a sufficient amount of the actinic radiation is applied to the photopolymerized layer for a time to form a substantially photopolymerized layer. A substantially photopolymerized layer means that greater than 60 mole percent of the aliphatic unsaturation present in the reactant species prior to reaction has been consumed as a result of the light activated addition reaction of the silicon-bonded hydrogen with the aliphatic unsaturated species. Preferably, such polymerization occurs in less than 30 minutes, more preferably in less than 10 minutes, and even more preferably in less than 5 minutes or less than 1 minute. In certain embodiments, such polymerization can occur in less than 10 seconds.

Examples of sources of actinic radiation include tungsten halogen lamps, xenon arc lamps, mercury arc lamps, incandescent lamps, germicidal lamps, fluorescent lamps, and lasers. There are a variety of possible UV sources that can be used. One class is low intensity, low-pressure mercury bulbs. These include germicidal bulbs emitting primarily at 254 nm, Blacklight bulbs with peak emissions near 350 or 365 nm, and Blacklight Blue bulbs with emissions similar to Blacklight bulbs but using special glass to filter out light above 400 nm. Such systems are available from VWR, West Chester, Pa. Other classes include high intensity continuously emitting systems such as those available from Fusion UV Systems, Gaithersburg, Md.; high intensity pulsed emission systems such as those available from XENON Corporation Wilmington, Mass.; high intensity spot curing systems such as those available from LESCO Corporation Torrance, Calif.; and LED-based systems such as those available from UV Process Supply, Inc. Chicago, Ill. Laser systems may also be used for initiating polymerization in the photopolymerizable layer.

Actinic radiation may be applied to gel the photopolymerizable layer such that the bonded components can be handled or moved to the next step of the manufacturing process.

The photopolymerizable layer may be heated before, during, and/or after actinic radiation is applied. Heating may be carried out to accelerate formation of the photopolymerized layer, or to decrease the amount of time the photopolymerizable layer is exposed to actinic radiation during photopolymerization. Heating may also be carried out in order to lower the viscosity of the photopolymerizable layer, for example, to facilitate the release of any entrapped gas. The disclosed methods are particularly advantageous to the extent they avoid harmful temperatures. Preferably, the disclosed methods involve exposure to actinic radiation at a temperature of less than less than 100° C., less than 80° C., less than 60° C., and most preferably, the photopolymerizable layer is at room temperature. Any heating means may be used such as an infrared lamp, a forced air oven, or a heating plate.

Photoinitiators can optionally be included in the photopolymerizable layer to increase the overall rate of polymerization. Useful photoinitiators include, for example, monoketals of α-diketones or α-ketoaldehydes and acyloins and their corresponding ethers (such as those disclosed in U.S. Pat. No. 6,376,569 (Oxman et al.)). Useful amounts include no greater than 50,000 parts by weight, and more preferably no greater than 5000 parts by weight, per one million parts of the photopolymerizable layer. If used, such photoinitiators are preferably included in an amount of at least 50 parts by weight, and more preferably at least 100 parts by weight, per one million parts of the photopolymerizable layer. Photoinitiators may only be added to the extent that they do not cause excessive yellowing in the polymerized layer after exposure to accelerated aging conditions.

Catalyst inhibitors can optionally be included in the composition used to form the photopolymerizable layer. Catalyst inhibitors may be used in order to extend the usable shelf life of the composition, however, catalyst inhibitors may also slow down decrease cure speed. In some embodiments, a catalyst inhibitor may be used in an amount sufficient to extend the usable shelf life of the composition without having an undesirable affect on cure speed of the composition. In some embodiments, the photopolymerizable composition comprises a catalyst inhibitor at a stoichiometric amount less than that of the platinum photocatalyst. Catalyst inhibitors are known in the art and include such materials as acetylenic alcohols (for example, see U.S. Pat. Nos. 3,989,666 (Niemi) and 3,445,420 (Kookootsedes et al.)), unsaturated carboxylic esters (for example, see U.S. Pat. Nos. 4,504,645 (Melancon), 4,256,870 (Eckberg), 4,347,346 (Eckberg), and 4,774,111 (Lo)) and certain olefinic siloxanes (for example, see U.S. Pat. Nos. 3,933,880 (Bergstrom), 3,989,666 (Niemi), and 3,989,667 (Lee et al.)).

In some embodiments, the photopolymerizable composition is free of catalyst inhibitor. Minimization of the amounts of materials that can act as catalyst inhibitors can be desirable to maximize the cure speed of the photopolymerizable layer in that active hydrosilylation catalyst generated upon irradiation of the composition is produced in the absence of materials that can attenuate the activity of said active catalyst.

The photopolymerizable layer can comprise one or more additives selected from the group consisting of nonabsorbing metal oxide particles, antioxidants, UV stabilizers, and combinations thereof. If used, such additives are used in amounts to produce the desired effect. Nonabsorbing metal oxide particles that are substantially transparent may be used. For example, a 1 mm thick disk of the nonabsorbing metal oxide particles mixed with photopolymerizable composition may absorb less than about 15% of the light incident on the disk. In other cases the mixture may absorb less than 10% of the light incident on the disk. Examples of nonabsorbing metal oxide particles include, but are not limited to, Al₂O₃, ZrO₂, TiO₂, V₂O₅, ZnO, SnO₂, ZnS, SiO₂, and mixtures thereof, as well as other sufficiently transparent non-oxide ceramic materials. The particles can be surface treated to improve dispersibility in the photopolymerizable composition. Examples of such surface treatment chemistries include silanes, siloxanes, carboxylic acids, phosphonic acids, zirconates, titanates, and the like. Techniques for applying such surface treatment chemistries are known. Silica (SiO₂) has a relatively low refractive index but it may be useful in some applications, for example, as a thin surface treatment for particles made of higher refractive index materials, to allow for more facile surface treatment with organosilanes. In this regard, the particles can include species that have a core of one material on which is deposited a material of another type.

If used, the nonabsorbing metal oxide particles are preferably included in the photopolymerizable layer in an amount of no greater than 85 wt. %, based on the total weight of the photopolymerizable layer. Preferably, the nonabsorbing metal oxide particles are included in an amount of at least 10 wt. %, and more preferably in an amount of at least 45 wt. %, based on the total weight of the photopolymerizable layer. Generally, the particles can range in size from 1 nanometer to 1 micron, preferably from 10 nanometers to 300 nanometers, more preferably, from 10 nanometers to 100 nanometers. This particle size is an average particle size, wherein the particle size is the longest dimension of the particles, which is a diameter for spherical particles. It will be appreciated by those skilled in the art that the volume percent of metal oxide particles cannot exceed 74 percent by volume given a monomodal distribution of spherical particles. Nonabsorbing metal oxide particles may only be added to the extent that they do not add undesirable color or haze. These particles may be added to produce a desired effect, for example, to modify the refractive index of the photopolymerized layer.

The optical assembly disclosed herein may be prepared by disposing the photopolymerizable composition between the two surfaces of the two components to be bonded together. The optical assembly disclosed herein may be prepared by providing a display panel; providing a substrate comprising a substantially transparent substrate; disposing a photopolymerizable composition on one of the display panel and the substrate, the photopolymerizable composition comprising: a silicon-containing resin comprising silicon-bonded hydrogen and aliphatic unsaturation, and a platinum photocatalyst present in an amount of from about 0.5 to about 30 parts of platinum per one million parts of the photopolymerizable composition; disposing the other of the display panel and the substrate on the photopolymerizable composition such that a photopolymerizable layer having a thickness of from greater than 10 um to about 12 mm, or from greater than 50 um to 5 mm, or from greater than 100 um to 3 mm, is formed between the display panel and the substrate; and photopolymerizing the photopolymerizable layer by applying actinic radiation having a wavelength of 700 nm or less.

An example of the above method comprises disposing a quantity or layer of the photopolymerizable composition on the surface of either component to be bonded. Next, the other component is placed in contact with the photopolymerizable composition such that a substantially uniform photopolymerizable layer is formed between the two surfaces. The two components are then held securely in place. If desired, uniform pressure may be applied across the top of the assembly. If desired, the thickness of the layer may be controlled by a gasket, standoffs, shims, and/or spacers used to hold the components at a fixed distance to each other. Masking may be required to protect components from overflow. Trapped pockets of air may be prevented or eliminated by vacuum or other means. Actinic radiation may then be applied as described above to photopolymerize the photopolymerizable layer.

The optical assembly may also be prepared by creating an air gap or cell between the two components to be bonded and then disposing the photopolymerizable composition into the cell. That is, the method comprises: providing a display panel; providing a substrate comprising a substantially transparent substrate or a polarizer; forming a seal between the display panel and the substrate so that a cell is formed between the display panel and the substrate, the cell having a thickness of from greater than 10 um to about 12 mm, or from greater than 50 um to 5 mm, or from greater than 100 um to 3 mm; disposing a photopolymerizable composition into the cell, the photopolymerizable composition comprising: a silicon-containing resin comprising silicon-bonded hydrogen and aliphatic unsaturation, and a platinum photocatalyst present in an amount of from about 0.5 to about 30 parts of platinum per one million parts of the photopolymerizable composition; and photopolymerizing the photopolymerizable composition by applying actinic radiation having a wavelength of 700 nm or less.

An example of the above method is described in U.S. Pat. No. 6,361,389 B1 (Hogue et. al) and includes adhering together the components at the periphery edges so that a seal along the periphery creates the air gap or cell. Adhering may be carried out using a bond tape such as a double-sided pressure sensitive adhesive tape, a gasket, an RTV seal, etc. Then, the photopolymerizable composition is poured between the two substrates along an opening in the top edge of the tape-bonded substrates and allowed to slowly permeate between the substrates by gravitational forces. Alternatively, the photopolymerizable composition is injected into the air gap via some pressurized injection means such as a syringe. Another opening is required to allow air to escape as the air gap is filled. Exhaust means such as vacuum may be used to facilitate the process. Actinic radiation may then be applied as described above to photopolymerize the photopolymerizable layer.

The optical assembly may be prepared using an assembly fixture such as the one described in U.S. Pat. No. 5,867,241 (Sampica et al.) In this method, a fixture comprising a flat plate with pins pressed into the flat plate is provided. The pins are positioned in a predetermined configuration to produce a pin field which corresponds to the dimensions of the display panel and of the component to be attached to the display panel. The pins are arranged such that when the display panel and the other components are lowered down into the pin field, each of the four corners of the display panel and other components is held in place by the pins. The fixture aids assembly and alignment of an optical assembly with suitable control of alignment tolerances. Additional embodiments of the assembly method described in Sampica et al. are also described. As described in U.S. Pat. No. 6,388,724 B1 (Campbell, et. al), standoffs, shims, and/or spacers may be used to hold components at a fixed distance to each other.

The optical assembly disclosed herein may comprise additional components typically in the form of layers. For example, a heating source comprising a layer of indium tin oxide or another suitable material may be disposed on one of the components such as substantially transparent substrate. Additional components are described in, for example, US 2008/0007675 A1 (Sanelle et al.).

The optical assembly disclosed herein may be used in a variety of optical devices including, but not limited to, a phone, a television, a computer monitor, a projector, or a sign. The optical device may comprise a backlight.

### EXAMPLES

### Experimental

An organosiloxane, silicone master batch, having aliphatic unsaturation and silicon-bonded hydrogen, was prepared by adding 500.0 g of Gelest VQM-135 (Gelest, Inc., Morrisville, Pa.) and 25.0 g of Dow Corning Syl-Off 7678 (Dow Corning, Midland, Mich.) to a 1 liter glass bottle. A stock catalyst solution was prepared by dissolving 33 mg of MeCpPtMe₃ (Alfa Aesar, Ward Hill, Mass.) in 1 mL of toluene. Silicone compositions having different amounts of the platinum catalyst were prepared by combining master batch and catalyst solution as follows. All compositions were prepared under safe conditions where light below a wavelength of 500 nm was excluded.

### Example 1

To a 100 mL amber jar was added 40.0 g of the silicone master batch and 20 μL of the catalyst solution (equivalent to 10 ppm platinum catalyst). The solution was mixed thoroughly with a metal spatula and was allowed to degas over several hours. Once the composition was degassed 6.2 g of the solution was poured into a plastic Petri dish having a diameter of 55 mm. The silicone solution was allowed to settle and was then cured by irradiation for 15 minutes under a UVP Blak-Ray Lamp Model XX-15L fitted with two 16 inch Philips TUV 15 W/G15 T8 Germicidal bulbs emitting primarily at 254 nm, followed by heating for 30 minutes at 80° C. in a forced air oven. The material cures to a tack-free solid in 1 to 2 minutes. The cured silicone disc was removed from the plastic Petri dish and was 2.7 mm in thickness at the center of the silicone disc. A transmission spectrum of the silicone was taken using a PerkinElmer Lambda 900 UV/VIS Spectrophotometer (PerkinElmer Instruments, Norwalk, Conn.). The transmission of the sample at 400 nm, not corrected for Fresnel reflections, was 93.8%. The sample was placed into a glass Petri dish to protect the surface from contamination by dust and debris and the sample was aged at 130° C. in a forced air oven for 1000 hours. Transmission data for the sample at 400 nm measured during the 1000 hour aging experiment are shown in Table 1. Transmission data for the sample at 460 nm measured during the 1000 hour aging experiment are shown in Table 3. Transmission data for the sample at 530 nm measured during the 1000 hour aging experiment are shown in Table 5. Transmission data for the sample at 670 nm measured during the 1000 hour aging experiment are shown in Table 7.

### Example 2

To a 100 mL amber jar was added 40.0 g of the silicone master batch and 30 μL of the catalyst solution (equivalent to 15 ppm platinum catalyst). The solution was mixed thoroughly with a metal spatula and was allowed to degas over several hours. Once the composition was degassed 6.2 g of the solution was poured into a plastic Petri dish having a diameter of 55 mm. The silicone solution was allowed to settle and was then cured by irradiation for 15 minutes under a UVP Blak-Ray Lamp Model XX-15L fitted with two 16 inch Philips TUV 15 W/G15 T8 Germicidal bulbs emitting primarily at 254 nm, followed by heating for 30 minutes at 80° C. in a forced air oven. The cured silicone disc was removed from the plastic Petri dish and was 2.7 mm in thickness at the center of the silicone disc. A transmission spectrum of the silicone was taken using a PerkinElmer Lambda 900 UV/VIS Spectrophotometer (PerkinElmer Instruments, Norwalk, Conn.). The transmission of the sample at 400 nm, not corrected for Fresnel reflections, was 93.2%. The sample was placed into a glass Petri dish to protect the surface from contamination by dust and debris and the sample was aged at 130° C. in a forced air oven for 1000 hours. Transmission data for the sample at 400 nm measured during the 1000 hour aging experiment are shown in Table 1. Transmission data for the sample at 460 nm measured during the 1000 hour aging experiment are shown in Table 3. Transmission data for the sample at 530 nm measured during the 1000 hour aging experiment are shown in Table 5. Transmission data for the sample at 670 nm measured during the 1000 hour aging experiment are shown in Table 7.

### Example 3

To a 100 mL amber jar was added 40.0 g of the silicone master batch and 40 μL of the catalyst solution (equivalent to 20 ppm platinum catalyst). The solution was mixed thoroughly with a metal spatula and was allowed to degas over several hours. Once the composition was degassed 6.2 g of the solution was poured into a plastic Petri dish having a diameter of 55 mm. The silicone solution was allowed to settle and was then cured by irradiation for 15 minutes under a UVP Blak-Ray Lamp Model XX-15L fitted with two 16 inch Philips TUV 15 W/G15 T8 Germicidal bulbs emitting primarily at 254 nm, followed by heating for 30 minutes at 80° C. in a forced air oven. The cured silicone disc was removed from the plastic Petri dish and was 2.7 mm in thickness at the center of the silicone disc. A transmission spectrum of the silicone was taken using a PerkinElmer Lambda 900 UV/VIS Spectrophotometer (PerkinElmer Instruments, Norwalk, Conn.). The transmission of the sample at 400 nm, not corrected for Fresnel reflections, was 92.6%. The sample was placed into a glass Petri dish to protect the surface from contamination by dust and debris and the sample was aged at 130° C. in a forced air oven for 1000 hours. Transmission data for the sample at 400 nm measured during the 1000 hour aging experiment are shown in Table 1. Transmission data for the sample at 460 nm measured during the 1000 hour aging experiment are shown in Table 3. Transmission data for the sample at 530 nm measured during the 1000 hour aging experiment are shown in Table 5. Transmission data for the sample at 670 nm measured during the 1000 hour aging experiment are shown in Table 7.

### Example 4

To a 100 mL amber jar was added 20.0 g of the silicone master batch and 25 μL of the catalyst solution (equivalent to 25 ppm platinum catalyst). The solution was mixed thoroughly with a metal spatula and was allowed to degas over several hours. Once the composition was degassed 6.2 g of the solution was poured into a plastic Petri dish having a diameter of 55 mm. The silicone solution was allowed to settle and was then cured by irradiation for 15 minutes under a UVP Blak-Ray Lamp Model XX-15L fitted with two 16 inch Philips TUV 15 W/G15 T8 Germicidal bulbs emitting primarily at 254 nm, followed by heating for 30 minutes at 80° C. in a forced air oven. The cured silicone disc was removed from the plastic Petri dish and was 2.7 mm in thickness at the center of the silicone disc. A transmission spectrum of the silicone was taken using a PerkinElmer Lambda 900 UV/VIS Spectrophotometer (PerkinElmer Instruments, Norwalk, Conn.). The transmission of the sample at 400 nm, not corrected for Fresnel reflections, was 92.3%. The sample was placed into a glass Petri dish to protect the surface from contamination by dust and debris and the sample was aged at 130° C. in a forced air oven for 1000 hours. Transmission data for the sample at 400 nm measured during the 1000 hour aging experiment are shown in Table 1. Transmission data for the sample at 460 nm measured during the 1000 hour aging experiment are shown in Table 3. Transmission data for the sample at 530 nm measured during the 1000 hour aging experiment are shown in Table 5. Transmission data for the sample at 670 nm measured during the 1000 hour aging experiment are shown in Table 7. By extrapolation of the results from Examples 1-4, the composition containing 30 ppm platinum would be expected to have a percent transmission at 400 nm, after 1000 hours at 130° C., of at least about 85%.

### Comparative Example 1

To a 100 mL amber jar was added 20.0 g of the silicone master batch and 50 μL of the catalyst solution (equivalent to 50 ppm platinum catalyst). The solution was mixed thoroughly with a metal spatula and was allowed to degas over several hours. Once the composition was degassed 6.2 g of the solution was poured into a plastic Petri dish having a diameter of 55 mm. The silicone solution was allowed to settle and was then cured by irradiation for 15 minutes under a UVP Blak-Ray Lamp Model XX-15L fitted with two 16 inch Philips TUV 15 W/G15 T8 Germicidal bulbs emitting primarily at 254 nm, followed by heating for 30 minutes at 80° C. in a forced air oven. The material cures to a tack-free solid in about 1 minute. The cured silicone disc was removed from the plastic Petri dish and was 2.7 mm in thickness at the center of the silicone disc. A transmission spectrum of the silicone was taken using a PerkinElmer Lambda 900 UV/VIS Spectrophotometer (PerkinElmer Instruments, Norwalk, Conn.). The transmission of the sample at 400 nm, not corrected for Fresnel reflections, was 88.9%. The sample was placed into a glass Petri dish to protect the surface from contamination by dust and debris and the sample was aged at 130° C. in a forced air oven for 1000 hours. Transmission data for the sample at 400 nm measured during the 1000 hour aging experiment are shown in Table 2. Transmission data for the sample at 460 nm measured during the 1000 hour aging experiment are shown in Table 4. Transmission data for the sample at 530 nm measured during the 1000 hour aging experiment are shown in Table 6. Transmission data for the sample at 670 nm measured during the 1000 hour aging experiment are shown in Table 8.

### Comparative Example 2

To a 100 mL amber jar was added 20.0 g of the silicone master batch and 100 μL of the catalyst solution (equivalent to 100 ppm platinum catalyst). The solution was mixed thoroughly with a metal spatula and was allowed to degas over several hours. Once the composition was degassed 6.2 g of the solution was poured into a plastic Petri dish having a diameter of 55 mm. The silicone solution was allowed to settle and was then cured by irradiation for 15 minutes under a UVP Blak-Ray Lamp Model XX-15L fitted with two 16 inch Philips TUV 15 W/G15 T8 Germicidal bulbs emitting primarily at 254 nm, followed by heating for 30 minutes at 80° C. in a forced air oven. The cured silicone disc was removed from the plastic Petri dish and was 2.7 mm in thickness at the center of the silicone disc. A transmission spectrum of the silicone was taken using a PerkinElmer Lambda 900 UV/VIS Spectrophotometer (PerkinElmer Instruments, Norwalk, Conn.). The transmission of the sample at 400 nm, not corrected for Fresnel reflections, was 84.6%. The sample was placed into a glass Petri dish to protect the surface from contamination by dust and debris and the sample was aged at 130° C. in a forced air oven for 1000 hours. Transmission data for the sample at 400 nm measured during the 1000 hour aging experiment are shown in Table 2. Transmission data for the sample at 460 nm measured during the 1000 hour aging experiment are shown in Table 4. Transmission data for the sample at 530 nm measured during the 1000 hour aging experiment are shown in Table 6. Transmission data for the sample at 670 nm measured during the 1000 hour aging experiment are shown in Table 8.

### Comparative Example 3

To a 100 mL amber jar was added 20.0 g of the silicone master batch and 200 μL of the catalyst solution (equivalent to 200 ppm platinum catalyst). The solution was mixed thoroughly with a metal spatula and was allowed to degas over several hours. Once the composition was degassed 6.2 g of the solution was poured into a plastic Petri dish having a diameter of 55 mm. The silicone solution was allowed to settle and was then cured by irradiation for 15 minutes under a UVP Blak-Ray Lamp Model XX-15L fitted with two 16 inch Philips TUV 15 W/G15 T8 Germicidal bulbs emitting primarily at 254 nm, followed by heating for 30 minutes at 80° C. in a forced air oven. The cured silicone disc was removed from the plastic Petri dish and was 2.7 mm in thickness at the center of the silicone disc. A transmission spectrum of the silicone was taken using a PerkinElmer Lambda 900 UV/VIS Spectrophotometer (PerkinElmer Instruments, Norwalk, Conn.). The transmission of the sample at 400 nm, not corrected for Fresnel reflections, was 79.4%. The sample was placed into a glass Petri dish to protect the surface from contamination by dust and debris and the sample was aged at 130° C. in a forced air oven for 1000 hours. Transmission data for the sample at 400 nm measured during the 1000 hour aging experiment are shown in Table 2. Transmission data for the sample at 460 nm measured during the 1000 hour aging experiment are shown in Table 4. Transmission data for the sample at 530 nm measured during the 1000 hour aging experiment are shown in Table 6. Transmission data for the sample at 670 nm measured during the 1000 hour aging experiment are shown in Table 8.

TABLE 1

| | % Transmission at 400 nm (%) | | | |
|---|---|---|---|---|
| 130° C. | Example 1 | Example 2 | Example 3 | Example 4 |
| Aging time | (10 ppm | (15 ppm | (20 ppm | (25 ppm |
| (hours) | cat.) | cat.) | cat.) | cat.) |
| 0 | 93.8 | 93.2 | 92.6 | 92.3 |
| 23 | 92.8 | 92.6 | 91.5 | 90.4 |
| 40 | 91.8 | 91.8 | 90.7 | 89.9 |
| 71 | 92.0 | 91.6 | 90.3 | 89.5 |
| 158 | 91.4 | 91.1 | 89.6 | 88.6 |
| 250 | 91.6 | 90.8 | 89.5 | 87.8 |
| 500 | 91.2 | 90.3 | 88.7 | 87.5 |
| 775 | 90.5 | 89.7 | 88.5 | 87.2 |
| 1000 | 90.4 | 89.8 | 88.4 | 87.2 |

TABLE 2

| | % Transmission at 400 nm | | |
|---|---|---|---|
| 130° C. | Comparative | Comparative | Comparative |
| Aging time | Ex. 1 | Ex. 2 | Ex. 3 |
| (hours) | (50 ppm cat.) | (100 ppm cat.) | (200 ppm cat.) |
| 0 | 88.9 | 84.6 | 79.4 |
| 23 | 84.6 | 75.1 | 56.5 |
| 40 | 84.1 | 74.8 | 56.4 |
| 71 | 82.6 | 72.4 | 54.7 |
| 158 | 81.7 | 71.3 | 53.4 |
| 250 | 81.3 | 71.1 | 53.7 |
| 500 | 81.2 | 71.0 | 52.9 |
| 775 | 81.0 | 70.5 | 52.2 |
| 1000 | 80.7 | 70.0 | 53.0 |

TABLE 3

| | % Transmission at 460 nm | | | |
|---|---|---|---|---|
| 130° C. | Example 1 | Example 2 | Example 3 | Example 4 |
| Aging time | (10 ppm | (15 ppm | (20 ppm | (25 ppm |
| (hours) | cat.) | cat.) | cat.) | cat.) |
| 0 | 94.4 | 94.3 | 94.3 | 94.3 |
| 23 | 93.3 | 93.7 | 92.9 | 91.9 |
| 40 | 92.7 | 92.9 | 92.1 | 91.6 |
| 71 | 92.6 | 92.6 | 91.8 | 91.3 |
| 158 | 92.3 | 92.5 | 91.3 | 90.7 |
| 250 | 92.5 | 92.0 | 91.1 | 89.8 |
| 500 | 92.3 | 91.5 | 90.5 | 89.6 |
| 775 | 91.6 | 91.3 | 90.2 | 89.4 |
| 1000 | 91.5 | 91.4 | 90.3 | 89.3 |

TABLE 4

| | % Transmission at 460 nm | | |
|---|---|---|---|
| 130° C. | Comparative | Comparative | Comparative |
| Aging time | Ex. 1 | Ex. 2 | Ex. 3 |
| (hours) | (50 ppm cat.) | (100 ppm cat.) | (200 ppm cat.) |
| 0 | 93.6 | 92.4 | 91.0 |
| 23 | 87.9 | 81.0 | 66.7 |
| 40 | 87.0 | 79.9 | 65.3 |
| 71 | 86.1 | 78.3 | 64.5 |
| 158 | 85.4 | 77.4 | 63.0 |
| 250 | 84.9 | 77.1 | 63.0 |
| 500 | 84.8 | 77.0 | 62.1 |
| 775 | 84.7 | 76.5 | 61.4 |
| 1000 | 84.5 | 76.1 | 62.1 |

TABLE 5

| | % Transmission at 530 nm | | | |
|---|---|---|---|---|
| 130° C. | Example 1 | Example 2 | Example 3 | Example 4 |
| Aging time | (10 ppm | (15 ppm | (20 ppm | (25 ppm |
| (hours) | cat.) | cat.) | cat.) | cat.) |
| 0 | 94.5 | 94.6 | 94.6 | 94.6 |
| 23 | 93.6 | 94.1 | 93.4 | 92.9 |
| 40 | 93.0 | 93.4 | 92.9 | 92.5 |
| 71 | 93.1 | 93.2 | 92.6 | 92.3 |
| 158 | 92.7 | 93.3 | 92.3 | 91.8 |
| 250 | 93.1 | 92.9 | 92.2 | 91.3 |
| 500 | 92.8 | 92.5 | 91.6 | 91.0 |
| 775 | 92.4 | 92.4 | 91.7 | 91.0 |
| 1000 | 92.2 | 92.4 | 91.6 | 90.8 |

TABLE 6

| | % Transmission at 530 nm | | |
|---|---|---|---|
| 130° C. | Comparative | Comparative | Comparative |
| Aging time | Ex. 1 | Ex. 2 | Ex. 3 |
| (hours) | (50 ppm cat.) | (100 ppm cat.) | (200 ppm cat.) |
| 0 | 94.4 | 94.2 | 93.9 |
| 23 | 89.9 | 85.1 | 74.5 |
| 40 | 89.1 | 84.1 | 73.0 |
| 71 | 88.5 | 82.8 | 72.2 |
| 158 | 87.9 | 82.0 | 70.7 |
| 250 | 87.4 | 81.7 | 70.7 |
| 500 | 87.4 | 81.6 | 69.8 |
| 775 | 87.5 | 81.2 | 69.2 |
| 1000 | 87.2 | 80.8 | 69.8 |

TABLE 7

| | % Transmission at 670 nm | | | |
|---|---|---|---|---|
| 130° C. | Example 1 | Example 2 | Example 3 | Example 4 |
| Aging time | (10 ppm | (15 ppm | (20 ppm | (25 ppm |
| (hours) | cat.) | cat.) | cat.) | cat.) |
| 0 | 94.5 | 94.5 | 94.5 | 94.6 |
| 23 | 93.6 | 94.2 | 93.9 | 93.5 |
| 40 | 93.2 | 93.8 | 93.6 | 93.4 |
| 71 | 93.6 | 93.8 | 93.6 | 93.5 |
| 158 | 93.3 | 93.9 | 93.3 | 93.0 |
| 250 | 93.4 | 93.7 | 93.2 | 92.7 |
| 500 | 93.3 | 93.3 | 92.8 | 92.5 |
| 775 | 92.7 | 93.1 | 92.8 | 92.5 |
| 1000 | 92.6 | 93.2 | 92.7 | 92.4 |

TABLE 8

| | % Transmission at 670 nm | | |
|---|---|---|---|
| 130° C. | Comparative | Comparative | Comparative |
| Aging time | Ex. 1 | Ex. 2 | Ex. 3 |
| (hours) | (50 ppm cat.) | (100 ppm cat.) | (200 ppm cat.) |
| 0 | 94.4 | 94.4 | 94.4 |
| 23 | 92.2 | 89.7 | 83.9 |
| 40 | 91.7 | 89.1 | 82.8 |
| 71 | 91.5 | 88.3 | 82.3 |
| 158 | 91.0 | 87.7 | 81.0 |
| 250 | 90.5 | 87.3 | 80.8 |
| 500 | 90.7 | 87.3 | 80.3 |
| 775 | 90.7 | 87.0 | 79.8 |
| 1000 | 90.5 | 86.8 | 80.2 |

### Example 5

To a 100 mL amber jar was added 40.0 g of the silicone master batch and 20 μL of the catalyst solution (equivalent to 10 ppm platinum catalyst). The solution was mixed thoroughly with a metal spatula and was allowed to degas over several hours. Once the composition was degassed curing experiments were performed to determine the time to gel and time to tack free for the formulation under varying curing conditions. Aliquots of the solution were placed onto glass slides and the silicones were irradiated under a variety of conditions. Three curing conditions were evaluated to determine the time to gel and time to tack free; 1. irradiation with a UVP Blak-Ray Lamp Model XX-15L fitted with two 16 inch GE F15T8-BL blacklight bulbs emitting primarily at 365 nm (˜6 mW/cm²), 2. a UVP Blak-Ray Lamp Model XX-15L fitted with two 16 inch GE F15T8-BL blacklight bulbs emitting primarily at 365 nm (˜6 mW/cm²), followed by heating at 80° C. on a hotplate, and 3. irradiation with wavelengths of between 300 and 400 nm from a Super Spot Max Fiber Optic Light source (available from LESCO, Torrance, Calif.) at a distance of 2 cm. The intensity of the light was ˜1 W/cm² at the surface of the silicone. The time to gel and time to tack free were determined by probing the surface of the silicone on the glass slide with the tip of a tweezer. Data for the time to gel and time to tack free are shown in Tables 9 and 10 respectively.

### Example 6

To a 100 mL amber jar was added 40.0 g of the silicone master batch and 40 μL of the catalyst solution (equivalent to 20 ppm platinum catalyst). The solution was mixed thoroughly with a metal spatula and was allowed to degas over several hours. Once the composition was degassed curing experiments were performed to determine the time to gel and time to tack free for the formulation under varying curing conditions. Aliquots of the solution were placed onto glass slides and the silicones were irradiated under a variety of conditions. Three curing conditions were evaluated to determine the time to gel and time to tack free; 1. irradiation with a UVP Blak-Ray Lamp Model XX-15L fitted with two 16 inch GE F15T8-BL blacklight bulbs emitting primarily at 365 nm (˜6 mW/cm²), 2. a UVP Blak-Ray Lamp Model XX-15L fitted with two 16 inch GE F15T8-BL blacklight bulbs emitting primarily at 365 nm (˜6 mW/cm²), followed by heating at 80° C. on a hotplate, and 3. irradiation with wavelengths of between 300 and 400 nm from a Super Spot Max Fiber Optic Light source (available from LESCO, Torrance, Calif.) at a distance of 2 cm. The intensity of the light was ˜1 W/cm² at the surface of the silicone. The time to gel and time to tack free were determined by probing the surface of the silicone on the glass slide with the tip of a tweezer. Data for the time to gel and time to tack free are shown in Tables 9 and 10 respectively.

### Example 7

To a 100 mL amber jar was added 40.0 g of the silicone master batch and 60 μL of the catalyst solution (equivalent to 30 ppm platinum catalyst). The solution was mixed thoroughly with a metal spatula and was allowed to degas over several hours. Once the composition was degassed curing experiments were performed to determine the time to gel and time to tack free for the formulation under varying curing conditions. Aliquots of the solution were placed onto glass slides and the silicones were irradiated under a variety of conditions. Three curing conditions were evaluated to determine the time to gel and time to tack free; 1. irradiation with a UVP Blak-Ray Lamp Model XX-15L fitted with two 16 inch GE F15T8-BL blacklight bulbs emitting primarily at 365 nm (˜6 mW/cm²), 2. a UVP Blak-Ray Lamp Model XX-15L fitted with two 16 inch GE F15T8-BL blacklight bulbs emitting primarily at 365 nm (˜6 mW/cm²), followed by heating at 80° C. on a hotplate, and 3. irradiation with wavelengths of between 300 and 400 nm from a Super Spot Max Fiber Optic Light source (available from LESCO, Torrance, Calif.) at a distance of 2 cm. The intensity of the light was ˜1 W/cm² at the surface of the silicone. The time to gel and time to tack free were determined by probing the surface of the silicone on the glass slide with the tip of a tweezer. Data for the time to gel and time to tack free are shown in Tables 9 and 10 respectively.

TABLE 9

| | Curing Conditions (time to gel) | | |
|---|---|---|---|
| | | 365 nm | |
| | 365 nm | (~6 mW/cm²), | 300-400 nm |
| Example | (~6 mW/cm²) | 80° C. hotplate | (~1 W/cm²) |
| 5 | 5-7 minutes | 2-3 minutes | 5 seconds |
| 6 | 2-3 minutes | 1-2 minutes | 2-3 seconds |
| 7 | 2-3 minutes | 1-2 minutes | 1-2 seconds |

TABLE 10

| | Curing Conditions (time to tack free) | | |
|---|---|---|---|
| | | 365 nm | |
| | 365 nm | (~6 mW/cm²), | 300-400 nm |
| Example | (~6 mW/cm²) | 80° C. hotplate | (~1 W/cm²) |
| 5 | 15 minutes | 7-8 minutes | 15 seconds |
| 6 | 10 minutes | 4-5 minutes | 5 seconds |
| 7 | 10 minutes | 3-4 minutes | 5 seconds |

For comparison purposes, review of the technical data sheet for SYLGARD 184 (available from Dow Corning), a commercially available thermally cured silicone, having similar viscosity, Shore A hardness and mechanical properties to the silicone of examples 5, 6, and 7 has a recommended curing schedule of 24 hours at 23° C., 4 hours at 65° C., or 1 hour at 100° C. (data taken from the SYLGARD 184 Silicone Elastomer Technical Data Sheet).

A number of embodiments of the invention have been described. Nevertheless, it will be understood that various modifications may be made without departing from the spirit and scope of the invention. Accordingly, other embodiments are within the scope of the following claims.

1. An optical assembly comprising:
a display panel;
a substantially transparent substrate; and
a photopolymerizable layer disposed between the display panel and the substantially transparent substrate, the photopolymerizable layer having a thickness of from greater than 10 um to about 12 mm and comprising:
a silicon-containing resin comprising silicon-bonded hydrogen and aliphatic unsaturation, and
a platinum photocatalyst present in an amount of from about 0.5 to about 30 parts of platinum per one million parts of the photopolymerizable layer.

2. The optical assembly of claim 1, the photopolymerizable layer being free of catalyst inhibitor.

3. The optical assembly of claim 1, the photopolymerizable layer comprising a catalyst inhibitor at a stoichiometric amount less than that of the platinum photocatalyst.

4. The optical assembly of claim 1, the silicon-containing resin comprising an organosiloxane.

5. The optical assembly of claim 1, the silicon-containing resin comprising a first organosiloxane having units of the formula:
R¹ₐH_{c}SiO_{(4-a-c)/2}
wherein:
R¹ is a monovalent, straight-chained, branched or cyclic, unsubstituted or substituted, hydrocarbon group that is free of aliphatic unsaturation and has from 1 to 18 carbon atoms;
a is 0, 1, 2, or 3;
c is 0, 1, or 2; and
the sum of a+c is 0, 1, 2, or 3;
with the provisos that there is on average at least one silicon-bonded hydrogen present per molecule.

6. The optical assembly of claim 5, wherein at least 90 mole percent of the R¹ groups are methyl.

7. The optical assembly of claim 5, wherein at least 20 mole percent of the R¹ groups are aryl, aralkyl, alkaryl, or combinations thereof.

8. The optical assembly of claim 7, wherein the R¹ groups are phenyl.

9. The optical assembly of claim 1, the silicon-containing resin comprising a second organosiloxane, the second organosiloxane having units of the formula:
R¹ₐR²_{b}SiO_{(4-a-b)/2}
wherein:
R¹ is a monovalent, straight-chained, branched or cyclic, unsubstituted or substituted, hydrocarbon group that is free of aliphatic unsaturation and has from 1 to 18 carbon atoms;
R² is a monovalent hydrocarbon group having aliphatic unsaturation and from 2 to 10 carbon atoms;
a is 0, 1, 2, or 3;
b is 0, 1, 2, or 3; and
the sum a+b is 0, 1, 2, or 3;
with the provisos that there is on average at least one R² present per molecule.

10. The optical assembly of claim 9, wherein at least 90 mole percent of the R¹ groups are methyl.

11. The optical assembly of claim 9, wherein at least 20 mole percent of the R¹ groups are aryl, aralkyl, alkaryl, or combinations thereof.

12. The optical assembly of claim 11, wherein the R¹ groups are phenyl.

13. The optical assembly of claim 1, wherein the platinum photocatalyst is selected from the group consisting of Pt(II) β-diketonate complexes, (η⁵-cyclopentadienyl)tri(σ-aliphatic)platinum complexes, C₁₋₂₀-aliphatic substituted (η⁵-cyclopentadienyl)tri(σ-aliphatic)platinum complexes, and C₇₋₂₀-aromatic substituted (η⁵-cyclopentadienyl)tri(σ-aliphatic)platinum complexes.

14. The optical assembly of claim 1, wherein the platinum photocatalyst is selected from the group consisting of (η⁵-cyclopentadienyl)tri(σ-aliphatic)platinum complexes and C₁₋₂₀-aliphatic substituted (η⁵-cyclopentadienyl)tri(σ-aliphatic)platinum complexes.

15. The optical assembly of claim 1, the photopolymerizable layer having a thickness of from greater than 10 um to about 5 mm.

16. The optical assembly of claim 1, the display panel comprising a liquid crystal display panel.

17. The optical assembly of claim 1, the substantially transparent substrate comprising a touch screen.

18. A method of making an optical assembly, comprising:
providing a display panel;
providing a substrate comprising a substantially transparent substrate or a polarizer;
disposing a photopolymerizable composition on one of the display panel and the substrate, the photopolymerizable composition comprising:
a silicon-containing resin comprising silicon-bonded hydrogen and aliphatic unsaturation, and
a platinum photocatalyst present in an amount of from about 0.5 to about 30 parts of platinum per one million parts of the photopolymerizable composition;
disposing the other of the display panel and the substrate on the photopolymerizable composition such that a photopolymerizable layer having a thickness of from greater than 10 um to about 12 mm is formed between the display panel and the substrate; and
photopolymerizing the photopolymerizable layer by applying actinic radiation having a wavelength of 700 nm or less.

19. A method of making an optical assembly, comprising:
providing a display panel;
providing a substrate comprising a substantially transparent substrate or a polarizer;
forming a seal between the display panel and the substrate so that a cell is formed between the display panel and the substrate, the cell having a thickness of from greater than 10 um to about 12 mm;
disposing a photopolymerizable composition into the cell, the photopolymerizable composition comprising:
a silicon-containing resin comprising silicon-bonded hydrogen and aliphatic unsaturation, and
a platinum photocatalyst present in an amount of from about 0.5 to about 30 parts of platinum per one million parts of the photopolymerizable composition; and
photopolymerizing the photopolymerizable composition by applying actinic radiation having a wavelength of 700 nm or less.

20-22. (canceled)

23. An optical device comprising the optical assembly of claim 1, wherein the optical device comprises a handheld device comprising a display, a television, a computer monitor, a laptop display, a digital sign.
